(19) United States
(12) Patent Application Publication
(10) Pub. No.: US 2007/0254184 A1
(43) Pub. Date: Nov. 1, 2007

(54) Organic Electric Field Light Emitting Display

(75) Inventor: Chiaki DOMOTO, Shiga (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 11/679,776

(22) Filed: Feb. 27, 2007

(30) Foreign Application Priority Data
Feb. 27, 2006 (JP) 2006-050833

(51) Int. Cl. B32B 15/08

(52) U.S. Cl. 428/690

(57) ABSTRACT

According to one aspect of the present invention, an element substrate, a first electrode formed on the element substrate, an organic film formed on the first electrode, and a second electrode formed on the organic film are provided, and an upper surface of the first electrode is set in a predetermined plane direction in accordance with a crystal structure of a material forming the first electrode.

### BACKGROUND OF THE INVENTION

1. Field of the Invention

The present invention relates to an organic electric field light emitting display.

2. Description of the Related Art

There exist such self light emitting type displays as organic EL displays, which have been developed in recent years. Such an organic EL display has a configuration in which an anode, an organic EL film and a cathode are layered in sequence on a transparent substrate, such as a glass substrate.

Thus, in the organic EL display, when a current flows between the anode and the cathode, holes are injected into the organic EL film from the anode, and electrons are injected into the organic EL film from the cathode. The holes injected from the anode and the electrons injected from the cathode recombine into excitons, and these excitons make the organic EL film emit light, so that a desired image is displayed on the organic EL display.

Because of a light emitting mechanism described above, the efficiency of light emission of the organic EL display can be improved when the efficiency of injection of holes from the anode and electrons from the cathode into the organic EL film is increased. As a concrete method for increasing the efficiency of injection, a method for selecting an electrode material having a smaller work function for the cathode and an electrode material having a greater work function for the anode is conventionally general. Japanese Patent Application Laid-Open No. 2002-65578 can be cited as an example of a document in which an electrode material having a smaller work function is selected for the cathode.

### SUMMARY OF THE INVENTION

According to one aspect of the present invention, an organic electron field light emitting display provides an element substrate, a first electrode, an organic film and a second electrode. The first electrode is formed on the element substrate. The organic film is formed on the first electrode. The second electrode is formed on the organic film. The first electrode is set in a plane direction in accordance with a crystal structure of a material forming the first electrode.

These and other features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional diagram showing an organic EL display according to an embodiment of the present invention;

FIG. 2 is a diagram illustrating a crystal structure of a face centered cubic structure;

FIG. 3 is a diagram illustrating a crystal structure of a body centered cubic structure;

FIG. 4 is a diagram illustrating a crystal structure of a hexagonal close packed structure; and

FIG. 5 is a cross sectional diagram illustrating the crystal structure of the hexagonal close packed structure.

### DESCRIPTION OF THE PREFERRED EMBODIMENTS

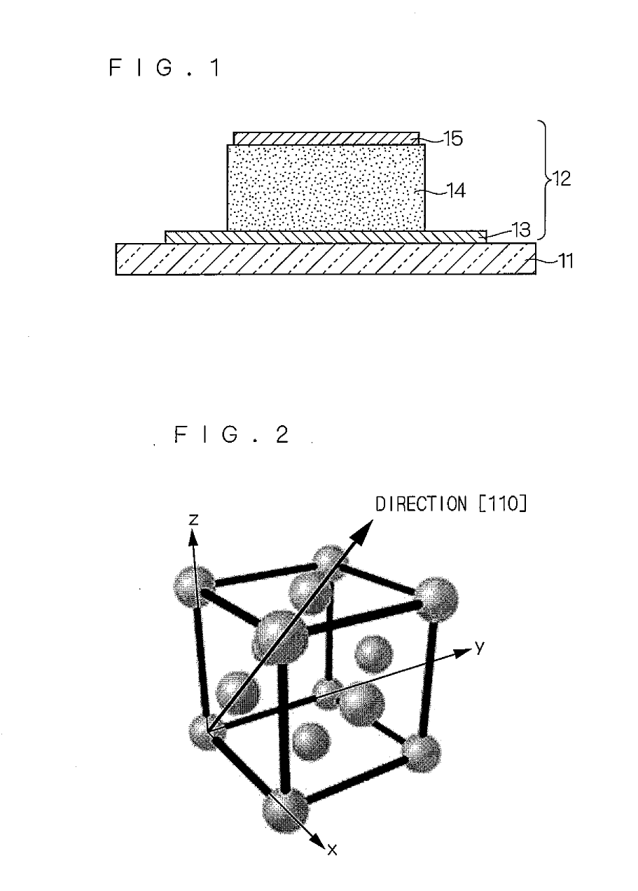

FIG. 1 is a cross sectional diagram showing an organic EL display which is an organic electrical field light emitting display. An element substrate 11 of the organic EL display shown in FIG. 1 is a glass plate in a rectangular form for supporting an organic EL element 12. As a material for the element substrate 11, generally, glass having insulating properties is used, but plastic or the like may also be used. Further, a circuit such as a TFT (thin film transistor) for controlling a current that flows through the organic EL element 12 is formed on the element substrate 11, which is not shown in FIG. 1. Here, the present invention is not limited to an active type organic EL display having an active element such as TFT, but may be applied to a passive type organic EL display which does not have an active element.

Though the organic EL elements 12 are arranged in a matrix form on the element substrate 11 to form an organic EL display, FIG. 1 shows only one organic element 12. Further, the organic EL element 12 shown in FIG. 1 has a configuration in which an anode 13, an organic EL film 14 and a cathode 15 are layered in sequence.

The anode 13 is formed, for example, by sputtering and vapor depositing a material having conductivity and properties of reflecting light (such as aluminum or an alloy thereof on the element substrate 11. Though not shown in FIG. 1, it is necessary to form a switching element (such as TFT or the like) for controlling supply of a current to the organic EL element 12. In a case of a bottom emission type organic EL display which is different from that of FIG. 1, a material having conductivity and light transmittance such as indium tin oxide (ITO) is sometimes used for the anode.

The organic EL film 14 may be of a single layer type made up of only a light emitting layer, or of a multilayer type including one or more function layers ,in addition to the light emitting layer. The function layer may be a hole injection layer, a hole transporting layer, an electron transporting layer, an electron injection layer, or a combination thereof. This organic EL film 14 is formed by, for example, vacuum vapor deposition. As the light emitting layer of the organic EL film 14, an aluminum complex such as Alq₃ or the like can be used in a case of a low molecular weight material, and a π conjugate polymer such as PPV or the like, or a low molecular pigment containing polymer such as PVK or the like can be used in a case of a high molecular weight material.

A material having conductivity and light transmittance, such as indium tin oxide (ITO), or a metal material, such as magnesium or calcium, having a very thin film thickness in the tens of nanometers is used for the cathode 15. Further, the cathode 15 is formed by sputtering or a vacuum vapor deposition method with indium tin oxide or a metal material such as magnesium. In a case of a bottom emission type organic EL display which is different from that of FIG. 1, a conductive material which reflects light, such as aluminum, is sometimes used for the cathode.

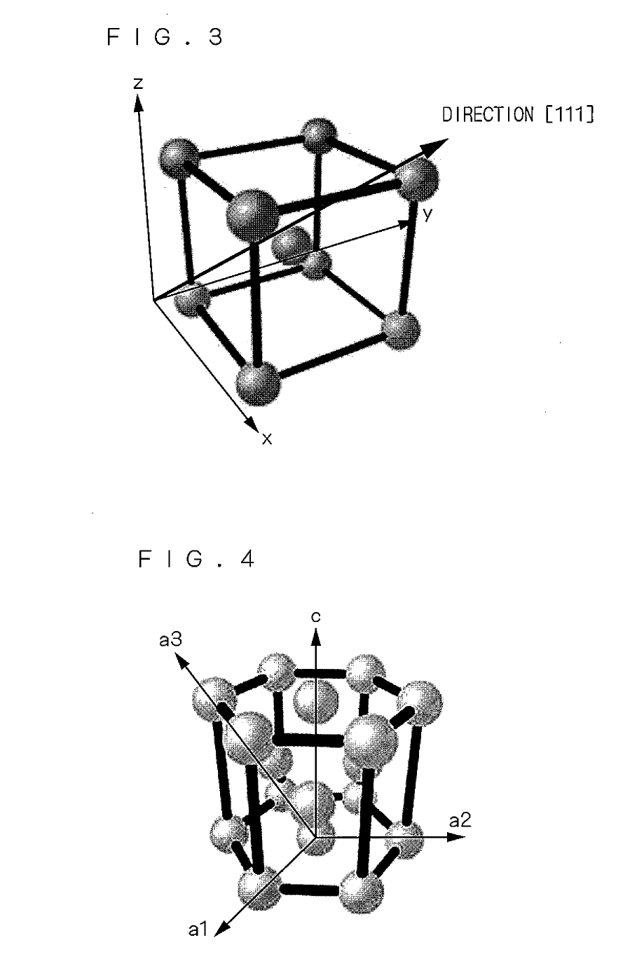

In a case of the present embodiment, aluminum is used for the anode 13 and the organic EL film 14 is layered on the plane (110) of the aluminum. When a plane direction of the surface (upper surface) of the aluminum forming the anode 13 is set to plane (110), the efficiency of hole injection increases in comparison with a case where the plane direction is not controlled, as in the conventional art. This is because the crystal structure of aluminum is a face centered cubic structure, and therefore, the plane where adjacent atoms become closest is set to plane (110). FIG. 2 shows the crystal structure of aluminum which the anode 13 is made of. As shown in FIG. 2, aluminum which the anode 13 is made of has a face centered cubic structure, and the direction [110] shown by the arrow in FIG. 2 is the direction in which adjacent atoms become closest. The plane perpendicular to this direction [110] is plane (110).

Plane (110) of aluminum where adjacent atoms become closest is a plane where spread of electron cloud (wave function) is wider in comparison with other planes. Therefore, a electron cloud (wave function) of the organic EL film 14 layered on plane (110) of aluminum spreads so as to largely overlap with spread of electron cloud (wave function) of plane (110) of aluminum, and this is considered to be the reason why the efficiency of hole injection increases. As the method for measuring the plane direction of the anode 13, conventionally used X ray diffractometry (XRD) can be used for measurement.

In a case where aluminum is used for the anode 13, the surface of the anode 13 becomes plane (111) when the anode 13 is formed on the element substrate 11 by sputtering, and after that, the surface of the anode 13 changes from plane (111) into plane (211) by annealing. Therefore, in the present embodiment, it is necessary to form the anode 13 of aluminum so that the surface of the anode 13 is substantially set to plane (110). As such a method, a method for optimizing the temperature for annealing the anode 13 and/or a method for controlling the temperature and the pressure of the element substrate 11 during film formation can be cited as examples.

As other methods, a method for forming an insulating film or the like having a lot of tapered protrusions in its surface on the element substrate 11 and forming an aluminum film on the surface of this insulating film can be cited as examples. In a case where plane (111) of aluminum is converted to plane (110) by a taper of the protrusions, it is necessary to set the angle of the taper at 35.3 degrees and make a distance between the adjacent protrusions approximately the same as or smaller than the size of crystal grains. In a case where the aluminum film is formed by sputtering, the crystal grains become no greater than 1 μm, and therefore, it is preferable that the distance between the adjacent protrusions be no greater than 1 μm.

As the material for the anode 13, Be, Si, Co, Ni, Cu, Ge, Se, Mo, Ru, Rh, Pd, Te, Re, Os, Ir, Pt, Au or ITO can be selected, from the viewpoint of the work function. These materials all have a work function of no less than 4.6 eV. Though the above-described aluminum has small work function, it is the material used in the organic EL element as the anode or cathode.

Anode materials which can have a face centered cubic structure as does aluminum are Si, Ni, Cu, Ge, Rh, Pd, Ir, Pt and Au. When an organic EL film is layered on plane (110) of these materials as described above, the efficiency of hole injection increases.

Next, in a case where the anode 13 is formed using Mo having a body centered cubic structure, the efficiency of hole injection increases when plane (111) is set to the surface. This is because the crystal structure of Mo is a body centered cubic structure and the surface where adjacent atoms become closest is set to plane (111). FIG. 3 shows the crystal structure of Mo. As shown in FIG. 3, Mo has the body centered cubic structure, and the direction shown by the arrow in FIG. 3 is the direction in which adjacent atoms become closest. The plane perpendicular to this direction [111] is plane (111).

Plane (111) of Mo where adjacent atoms become closest is a plane where an electron cloud (wave function) spreads more widely in comparison with other planes. Therefore, the electron cloud (wave function) of the organic EL film 14 which is layered on the plane (111) of Mo spreads so as to largely overlap with the spread of electron cloud (wave function) on plane (111) of Mo, and this is considered to be the reason why the efficiency of hole injection increases. As such a method for setting the surface of the anode 13 to plane (111), a method for optimizing the temperature for annealing the anode 13 and/or a method for controlling the temperature and the pressure of the element substrate 11 during film formation can be cited as examples.

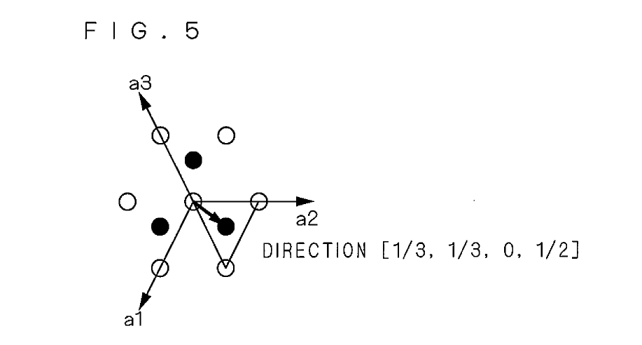

Next, in a case where an anode 13 is formed using Be having a hexagonal close packed structure, the efficiency of hole injection increases when plane (3302) is set to the surface. This is because the crystal structure of Be is a hexagonal close packed structure, and therefore, the plane where adjacent atoms become closest is set to plane (3302). FIGS. 4 and 5 show the crystal structure of Be. As shown in FIG. 4, Be has the hexagonal close packed structure, and the direction [⅓, ⅓, 0, ½] shown by the arrow in FIG. 5 is the direction where adjacent atoms become closest. The plane perpendicular to this direction [⅓, ⅓, 0, ½] is plane (3302). FIG. 5 is a cross sectional diagram showing the hexagonal close packed structure of FIG. 4 along a plane perpendicular to an axis C, and white circles indicate atoms in the first layer, while black circles indicate atoms in the second layer.

Plane (3302) of Be where adjacent atoms become closest is a plane where an electron cloud (wave function) spreads more widely in comparison with other planes. Therefore, the electron cloud (wave function) of the organic EL film 14 which is layered on plane (3302) of Be spreads so as to largely overlap with the spread of electron cloud (wave function) of plane (3302) of Be, and this is considered to be the reason why the efficiency of hole injection increases. As the anode materials which can have a hexagonal close packed structure, Co, Se, Ru, Te, Re or Os can be cited as other examples. As such a method for setting the surface of the anode 13 to plane (3362), a method for optimizing the temperature for annealing the anode 13 and/or a method for controlling the temperature and the pressure of the element substrate 11 during film formation can be cited as examples.

As described above, in the organic EL display according to the present embodiment, the organic EL film 14 is layered in a predetermined plane direction in accordance with the crystal structure of the material forming the anode 13, and therefore, the efficiency of injection of holes from the anode 13 increases. In addition, when the surface of the anode 13 is oriented in a predetermined plane direction, the efficiency of hole injection becomes uniform, and it becomes possible to inject the holes stably. Thus, the brightness in emission of light from the organic EL film 14 can be prevented from becoming inconsistent.

As described above, the anode 13 is formed as a film on the element substrate 11 before the formation of the organic EL film 14, as shown in FIG. 1. Therefore, the plane direction of the surface of the anode 13 can be set to plane (110) using any of a variety of processing methods, such as annealing. Meanwhile, in a case where aluminum is used for the cathode 15 and the rear surface (lower surface) of the cathode 15 is set to plane (110), the aluminum film is formed after the formation of the organic EL film 14, and thus, the processing method for setting the surface to plane (110) is limited in comparison with the case of the anode 13.

The organic EL display according to the present invention, however, is not limited to a configuration in which the anode is formed on the element substrate as shown in FIG. 1, but the cathode, the organic EL film and the anode may be layered in this order on the element substrate. Also in a case where the cathode is formed on the element substrate, the same effects as in the case of the above-described anode can be obtained by layering the organic EL film in a predetermined plane direction in accordance with the crystal structure of the material forming the cathode.

Concretely, Li, Na, Mg, K, Ca, Sc, Rb, Sr, Y, Cs, Ba, La or an AgMg alloy (Ag:Mg=9:1) can be selected as the material for the cathode 15 from the viewpoint of the work function. These materials all have a work function of no greater than 3.7 eV. Though, as described above, aluminum has small work function, it is the material used in the organic EL element as the anode 13 or the cathode 15. Further, though Ag has small work function, it is the material used in the organic EL element as the cathode 15.

In a case where aluminum is used as the material for the cathode 15, it has a face centered cubic structure as described above, and therefore, the efficiency of electron injection increases when the organic EL film is layered on plane (110). Ca, Sr or Ag can be cited as other examples of the cathode materials which can have the face centered cubic structure as does aluminum.

In a case where Li having a body centered cubic structure is used as the material for the cathode 15, the efficiency of electron injection increases when the organic EL film is layered on plane (111) as described above. Na, K, Rb, Cs or Ba can be cited as other examples of the cathode material which can have the body centered cubic structure as does Li.

In a case where Mg having a hexagonal close packed structure is used as the material for the cathode 15, the efficiency of electron injection increases when the organic EL film is layered on plane (3302) as described above. Sc, Y or La can be cited as other examples of the cathode materials which can have the hexagonal close packed structure as does Mg.

Though it is most preferable for the plane direction of the anode 13 or the cathode 15 described above to be set to the above-described value (plane (110) in a case where the anode 13 or cathode 15 is formed so as to have a face centered cubic structure, plane (111) in a case where the anode 13 or cathode 15 is formed of a material having a body centered cubic structure, plane (3302) in a case where the anode 13 or cathode 15 is formed of a material having a hexagonal close packed structure; hereinafter referred to as ideal value), a slight difference is allowable. Concretely, it is preferable for the plane direction of the anode 13 or the cathode 15 to be set to a plane direction within +/−10° relative to the plane direction of the above-described ideal value (more preferably, a plane direction within +/−5° relative to the plane direction of the above-described ideal value).

While the invention has been shown and described in detail, the foregoing description is in all aspects illustrative and not restrictive. It is therefore understood that numerous modifications and variations can be devised without departing from the scope of the invention.

What is claimed is:

1. An organic electric field light emitting display comprising:
an element substrate;
a first electrode formed on said element substrate;
an organic film formed on said first electrode; and
a second electrode formed on said organic film, wherein
said first electrode is set in a plane direction in accordance with a crystal structure of a material forming the first electrode.

2. The organic electric field light emitting display according to claim 1, wherein
said first electrode is formed of a material having a body centered cubic structure, and the plane direction of said first electrode is substantially set to plane (111).

3. The organic electric field light emitting display according to claim 1, wherein
said first electrode is formed of a material having a face centered cubic structure, and the plane direction of said first electrode is substantially set to plane (110).

4. The organic electric field light emitting display according to claim 1, wherein
said first electrode is formed of a material having a hexagonal close packed structure, and the plane direction of said first electrode is substantially set to plane (3302).

5. The organic electric field light emitting display according to claim 1, wherein
said first electrode is anode and said second electrode is cathode.

6. The organic electric field light emitting display according to claim 5, wherein
said first electrode comprises a material selected from the group consisting of Be, Si, Co, Ni, Cu, Ge, Se, Mo, Ru, Rh, Pd, Te, Re, Os, Ir, Pt or Au.

7. The organic electric field light emitting display according to claim 2, wherein
said first electrode is anode and said second electrode is cathode, wherein
said first electrode comprises Mo.

8. The organic electric field light emitting display according to claim 3, wherein
said first electrode is anode and said second electrode is cathode, wherein
said first electrode comprises a material selected from the group consisting of Al, Si, Ni, Cu, Ge, Rh, Pd, Ir, Pt or Au.

9. The organic electric field light emitting display according to claim 4, wherein
said first electrode is anode and said second electrode is cathode, wherein
said first electrode comprises a material selected from the group consisting of Be, Co, Se, Ru, Te, Re or Os.

10. The organic electric field light emitting display according to claim 1, wherein
said first electrode is cathode and said second electrode is anode.

11. The organic electric field light emitting display according to claim 10, wherein
said first electrode comprises a material selected from the group consisting of Li, Na, Mg, K, Ca, Al, Sc, Rb, Sr, Y, Cs, Ba, La, Ag or AgMg alloy.

12. The organic electric field light emitting display according to claim 2, wherein
said first electrode is cathode and said second electrode is anode, wherein
said first electrode comprises a material selected from the group consisting of Li, Na, K, Rb, Cs or Ba.

13. The organic electric field light emitting display according to claim 3, wherein
said first electrode is cathode and said second electrode is anode,
wherein
said first electrode comprises a material selected from the group consisting of Ca, Al, Sr, Ag or AgMg alloy.

14. The organic electric field light emitting display according to claim 4, wherein
said first electrode is cathode and said second electrode is anode,
wherein
said first electrode comprises a material selected from the group consisting of Mg, Sc, Y or La.
